(19) United States
(12) Patent Application Publication
(10) Pub. No.: US 2026/0228022 A1
(43) Pub. Date: Aug. 6, 2026

(54) INTEGRATION OF LIGHTWEIGHT ARTIFICIAL INTELLIGENCE MODEL IN CONFIGURABLE USER INTERFACE COMPONENT

(71) Applicant: Salesforce, Inc., San Francisco, CA (US)

(72) Inventors: Siva Aditya Yedida, Hyderabad (IN); Santosh Kumar Chikoti, Hyderabad (IN); Subhashini Puram, Hyderabad (IN); Venkat Ramana Reddy Parine, Hyderabad (IN)

(21) Appl. No.: 19/053,924

(22) Filed: Feb. 14, 2025

(30) Foreign Application Priority Data
Jan. 31, 2025 (IN) 202511008349

(51) Int. Cl. G06F 9/451

(52) U.S. Cl. CPC G06F 9/451

(57) ABSTRACT

Disclosed are some examples of integrating a lightweight artificial intelligence (AI) model in a configurable user interface (UI) component. In some implementations, a computing device obtains, from a repository, one or more pre-existing lightweight AI models. The computing device can store the obtained one or more AI models in local memory associated with a local application. The computing device can integrate the obtained one or more AI models within one or more configurable UI components. Integration can be facilitated using a scripting library configured to enable local execution of AI models in the local application at the computing device. The computing device can execute at least the integrated one or more AI models to generate output data, for instance, in an offline mode of the computing device using local data stored at the computing device.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### TECHNICAL FIELD

The present disclosure generally relates to the field of configurable user interface (UI) components, and more specifically, to incorporating artificial intelligence (AI) in configurable UI components.

### BACKGROUND

Various sectors including agriculture, disaster response, health and pharmaceuticals, field services, education, retail, and environmental monitoring face significant challenges when internet connectivity is unreliable or unavailable, such as in remote locations. Workers in these fields often struggle to access and analyze important information in a reasonable amount of time, hindering their ability to make informed decisions and respond effectively to pressing needs. With unreliable or unavailable network connectivity, it can be difficult to process data, for instance, to manage inventory, analyze customer preferences, optimize sales strategies, understand resource availability and logistics to coordinate relief efforts, respond to emergencies, and analyze data related to affected populations.

Conventional artificial intelligence (AI) tools have proved insufficient for efficient task management and better resource utilization. For instance, the incorporation of large language models (LLMs) for solving problems can impose significant operational burdens on organizations. These models, while powerful in some contexts, are resource-intensive, requiring substantial computational power for both training and inference. For simpler tasks, the use of such heavyweight solutions can lead to overkill, where the resources expended far exceed the value derived.

### BRIEF DESCRIPTION OF DRAWINGS

The included drawings are for illustrative purposes and serve only to provide examples of possible structures and processing operations for the disclosed techniques. These drawings in no way limit any changes in form and detail that may be made to implementations by one skilled in the art without departing from the spirit and scope of the disclosure.

FIG. 1 is a diagram showing an example of a system 100 for integrating a lightweight artificial intelligence (AI) model in a configurable user interface (UI) component, according to some implementations.

FIG. 2 is a diagram showing an example of a system 200 for integrating a lightweight AI model in a configurable UI component for performing sentiment analysis in a UI, according to some implementations.

FIG. 3 is a diagram showing an example of a UI 300A and a UI 300B for performing sentiment analysis, according to some implementations.

FIG. 4 is a flow diagram showing an example of a method 400 for integrating a lightweight AI model in a configurable UI component, according to some implementations.

FIG. 5 is a diagram showing an example of a computing environment 1000, according to some implementations.

Like reference symbols in the various drawings indicate like elements, in accordance with certain examples.

### DETAILED DESCRIPTION

The following description is directed to certain examples for the purposes of describing innovative aspects of various implementations. A person having skill in the art will readily recognize that the teachings herein can be applied in a multitude of different ways. The disclosed examples are provided to add context and aid in the understanding of the present disclosure. It will thus be apparent to one skilled in the art that the techniques described herein may be practiced without some or all of these specific details. In some instances, well-known process operations have not been described in detail in order to avoid unnecessarily obscuring the present disclosure. Other applications are possible, such that the following examples should not be taken as definitive or limiting either in scope or setting.

The described subject matter may be implemented in the context of any computer-implemented system, such as a software-based system, a hardware-based system, a database system or some combination thereof. Moreover, the described subject matter may be implemented in connection with two or more separate and distinct computer-implemented systems that cooperate and communicate with one another. One or more examples may be implemented in numerous ways, including as a process, an apparatus, a system, a device, a method, a computer-readable medium such as a non-transitory computer-readable storage medium containing computer-readable instructions or computer program code, or as a computer program product comprising a computer usable medium having computer-readable program code embodied therein.

In some of the disclosed implementations, lightweight artificial intelligence (AI) models can be integrated with configurable user interface (UI) components of a web page, a software application, a mobile app, etc. Examples of such configurable UI components are lightning web components (LWCs) provided by Salesforce, Inc. that can be run locally at a user's computing device. For instance, a pre-existing lightweight AI model downloaded to a user's device and deployed locally in one or more LWCs can have in-browser and in-device processing capabilities. Some of the disclosed techniques can be implemented in custom user interfaces (UIs) such as Visualforce pages provided by Salesforce, Inc., that developers can use to create applications and customize platforms. Some of the disclosed techniques also or alternatively can be implemented in a cloud-based platform such as Salesforce Experience Cloud that allows the building of portals, websites, mobile apps, etc. by customers, partners, and employees of an organization. Integrating lightweight AI models directly within components such as LWCs, executable in a browser or mobile app at a user's device, can expose capabilities offering a secure, efficient, and seamless solution, ensuring data privacy while enhancing workflow. Some capabilities of the disclosed techniques can include offline execution of AI models on local devices, so professionals can harness the power of AI to analyze data, gain insights, and enhance service delivery regardless of internet connectivity.

A lightweight AI model is generally designed to use minimal computational resources, allowing the model to run efficiently on devices with limited processing power, like mobile phones or embedded systems, while still maintaining acceptable accuracy. When compared to large, complex AI models, lightweight AI models have fewer parameters, translating to a smaller file size and less memory usage. The lightweight AI model generally prioritizes speed and efficiency over raw power, making the model ideal for edge computing environments where data is to be processed locally. Lightweight AI models can be deployed on devices with limited processing power, like smart wearables, without requiring a server in the cloud.

LWCs are components for building and otherwise configuring UIs. LWCs generally provide a UI framework that developers can use to create customized pages and functions, for instance, on the Salesforce, Inc. platform. Those skilled in the art will appreciate that LWCs are reusable components and can be used to build web pages, software applications and mobile apps.

Some implementations involve downloading pre-trained lightweight AI models to a user's device and fine-tuning them for specific use cases in a quick and cost-effective manner, significantly accelerating the local deployment of accurate and performant models. Instead of building models from scratch, fine-tuning commercial lightweight AI models such as those available on platforms like Hugging Face allows for rapid customization and achievement of results. Leveraging pre-trained models from Hugging Face, open-source libraries that are commercially viable can be incorporated, enabling quick deployment of AI functionalities like text generation, sentiment analysis, and summarization within a local application, that is, without a need for external servers, systems and services.

In some implementations, by running lightweight AI models directly in a browser or other local application at a user's computing device, tasks can be handled efficiently without the heavy resource demands or security risks associated with more complex, server-based models. For instance, by performing inference in-browser, there is no need for server calls, which can reduce latency, enhance processing speed, and ensure a more responsive and efficient user experience. AI functionalities can be immediately accessible within the local application.

In some implementations, downloaded AI models are executed offline using local data on a user's device and in a component such as a lightning web component (LWC). By enabling real-time data processing and analysis without relying on internet connectivity, some disclosed implementations can streamline complex AI problem-solving, enhancing both decision-making speed and efficiency in offline mode.

In some implementations, downloaded AI models can be cached locally at the user's device, avoiding deployment and scalability challenges and allowing AI-driven tasks to be scaled with less effort while maintaining control over private data.

Some implementations allow for rapid fine-tuning and integration of custom AI models using transformers.js directly within a browser, eliminating the complexities of server setups like Docker/Kubernetes and simplifying the process of deploying AI-driven solutions.

In some implementations, tasks such as speech-to-text conversion, document summarization, and content translation can be automated directly within a component such as a LWC, enhancing efficiency and control. Additionally, functionalities like auto-completion, pattern recognition, and generating customized reports based on user inputs become streamlined, further benefiting from the integration of lightweight AI models into configurable UI components.

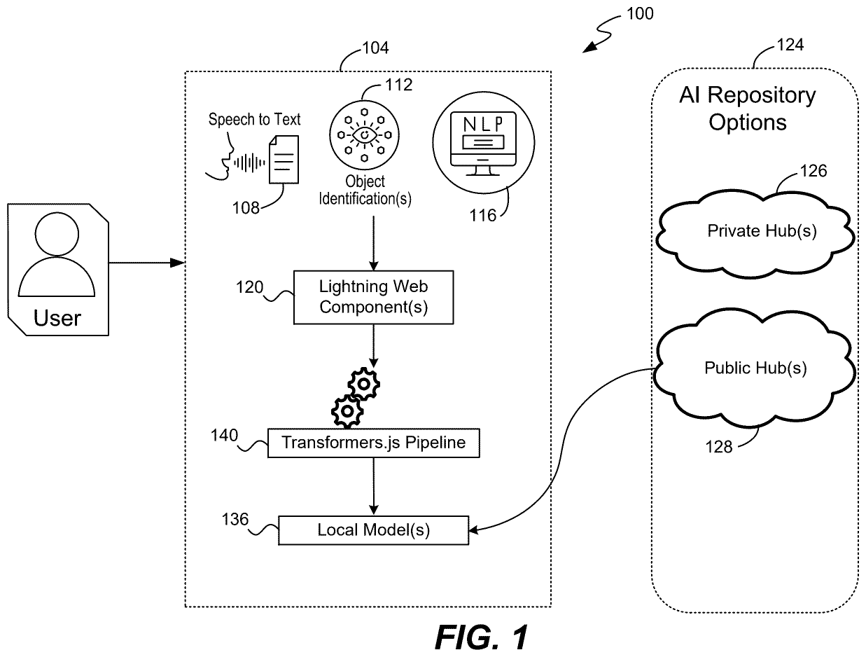

FIG. 1 is a diagram showing an example of a system 100 for integrating a lightweight AI model in a configurable UI component, according to some implementations. In FIG. 1, a user's computing device 104 is configured to receive user input from a user. For instance, user input can be in the form of text data 108 generated from user speech, one or more object identifications 112, and/or natural language processing (NLP) data 116. The user input can be provided to configurable UI components such as one or more LWCs 120 situated at device 104.

In FIG. 1, computing device 104 is configured to obtain, from an AI repository facility, one or more pre-existing lightweight AI models. As shown in FIG. 1, AI repository facility options 124 include one or more private hubs 126 and one or more public hubs 128. These hubs 126 and 128 can separately and collectively host a variety of different AI models.

For instance, device 104 can access the Hugging Face platform, one of public hubs 128, and select an AI model optimized for a browser. Device 104 can download a selected lightweight AI model from Hugging Face. The downloaded AI model(s) can be stored as one or more local models 136 in one or more memories of device 104, for instance, using node package manager (npm). The local model(s) 136 is/are associated with a local application such as a browser, which can be run on device 104. Other examples of local applications at device 104 include locally installed software applications, mobile apps in implementations where device 104 is a mobile device, or some combination thereof.

In FIG. 1, local model(s) 136 is/are integrated within one or more LWCs 120 situated at device 104. This integration is performed using a scripting library configured to enable local execution of local model(s) 136 in the browser or other local application at device 104. One example of such a scripting library is transformers.js, a JavaScript library, which is configured to enable a user's computing device to run AI models directly in a browser on the computing device.

To interact with LWCs, one or more pipelines such as a transformers.js pipeline 140 can be used. Transformers.js pipelines facilitate the use of pre-trained models directly in a local application such as a browser. Those skilled in the art will appreciate that transformers.js pipeline 140 abstracts away complexities of model loading, tokenization, and inference, allowing the user to focus on building an application. For instance, a pipeline function can be imported from the transformers.js library. Transformers.js pipeline 140 can be created by specifying a task to perform (e.g., text generation, sentiment analysis, translation). Input data can then be passed to the pipeline, which handles the input data and returns output data in a user-friendly format.

In FIG. 1, the integrated local model(s) can be executed, for instance, as part of running one or more LWCs 120, to generate output data. In some implementations, an integrated local model is run in an offline mode of device 104 using local data stored in one or more memories at device 104. For instance, device 104 can be offline when device 104 has no network connection and/or is unable to communicate with a server system.

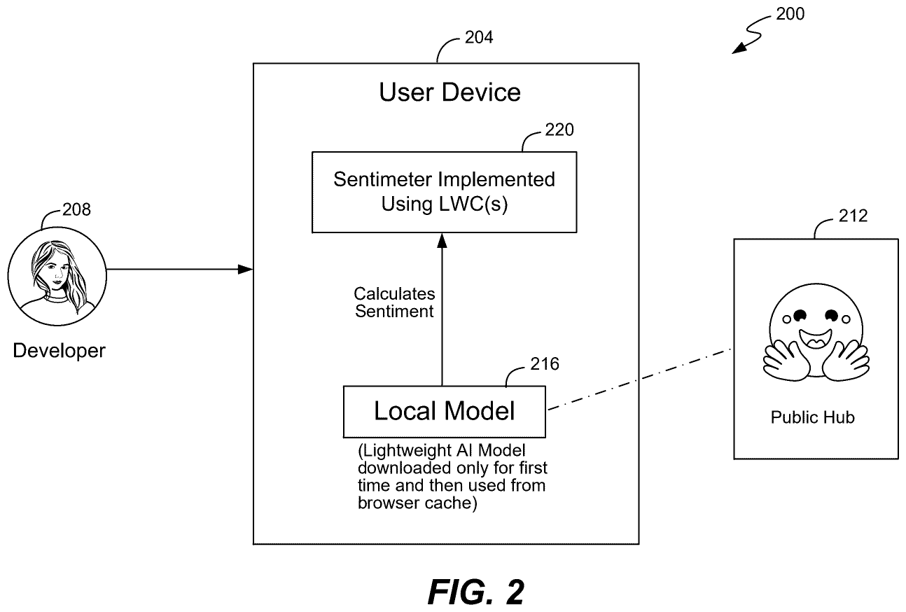

FIG. 2 is a diagram showing an example of a system 200 for integrating a lightweight AI model in a configurable UI component for performing sentiment analysis in a UI, according to some implementations. In FIG. 2, a computing device 204 of a user 208 is configured to download, from an AI repository facility such as a public hub 212, one or more pre-existing lightweight AI models. In this example, device 204 downloads into browser cache a pre-trained lightweight AI model providing sentiment analysis. The downloaded AI model is stored on device 204 as a local model 216. In this example, local model 216 can be further customized according to user input received at device 204. In some implementations, custom AI models can be built and trained per domain use case. These custom models can then be hosted in private or public hubs and used for specific applications and solutions.

Returning to FIG. 2, local model 216 is integrated within one or more LWCs situated at device 204 to build a local application providing sentiment analysis, referred to in this example as a sentimeter 220. This integration can be performed using transformers.js and a transformers.js pipeline as explained above. When sentimeter 220 is executed as part of running one or more LWCs at device 204, output data in the form of sentiment data can be generated. Sentimeter 220 can be added to a product record page using, for example, the Lightning App Builder provided by Salesforce, Inc.

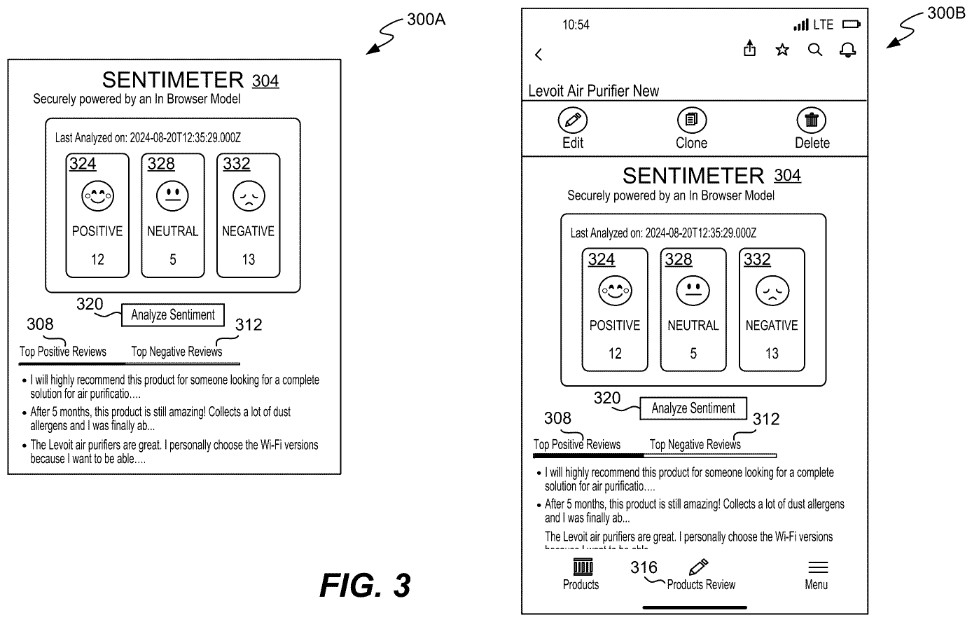

FIG. 3 is a diagram showing examples of UIs 300A and 300B for performing sentiment analysis, according to some implementations. In FIG. 3, a sentimeter 304 for performing sentiment analysis on product reviews has been built using techniques described herein. As explained with reference to FIGS. 1 and 2, one or more local models are run in a browser at the user's computing device, which can be a desktop computer in the case of UI 300A or a mobile device in the case of UI 300B. The client-side processing of sentimeter 304 in FIG. 3 uses local data displayed in the browser, such as top positive reviews 308 and top negative reviews 312, ensuring that such data need not be sent to external servers for analysis.

In FIG. 3, UIs 300A and 300B can be generated and loaded into a browser at the user's device. In this example, a single loading of LWCs providing such UIs can cause the local model to be loaded and start executing in the browser. With one or more clicks, sentimeter 304 can start analyzing product reviews 316. In this example, a local model processes input data in the form of incoming reviews, classifying them as positive, neutral or negative. Results are displayed within LWC components.

In FIGS. 2 and 3, sentiment analysis can be performed on customer feedback in near real time. In these examples, commercially available pre-trained AI models can be leveraged and integrated in a browser. This approach allows local models to be run directly from LWCs.

Returning to FIG. 3, In UI 300B, a user has selected a product, namely “Levoit Air Purifier.” This product has garnered numerous customer reviews. In some implementations, after an analyze sentiment button 320 is pressed, a progress bar provides near real time updates as reviews are fetched, tokenized and fed into the sentiment analysis model. Once the analysis is complete, sentiment scores 324, 328 and 332 can be persisted for each review and aggregated at the product level.

For each product, top positive reviews 308 and top negative reviews 312 can be higher-ranked or highlighted, providing a snapshot of customer sentiment. A user can click to drill down to see the sentiment classification at the individual review level. In this example, sentiment for a review is classified as positive when the user was satisfied with product usage. Likewise, the sentiment for another review is classified as negative when the user was not satisfied with product usage.

Those skilled in the art should appreciate that the sentiment analysis of FIGS. 2 and 3 are specific examples of a variety of AI-powered solutions. In some other examples, disclosed techniques are implemented to perform image-to-text conversion, document-based question generation, answering, text summarization, and text generation. These tools can be developed and deployed in offline mode, reducing the amount of infrastructure, resources, and coding required in server-based and cloud-based environments.

For instance, in retail, AI models running locally using the disclosed techniques can assist with inventory management by converting product images into text descriptions or automating customer service. In healthcare, offline AI models can help analyze medical records and summarize patient data for faster diagnosis. Offline execution of AI models using local data on devices can benefit field service agents in health, retail, disaster management and banking sectors. By allowing them to analyze data in real time without relying on internet connectivity, these models enhance decision-making efficiency and speed. This approach not only boosts productivity but also ensures data privacy, as sensitive information remains on the device, reducing the risk of breaches.

In some implementations, local models run offline can use local data in the form of images and/or text. This can provide data privacy, faster processing, and compatibility with both private and public model hubs, enhancing overall efficiency and security. Some of the disclosed implementations support plug-and-play solutions, which reduce development time and effort, enabling quick implementation of AI features without complex coding.

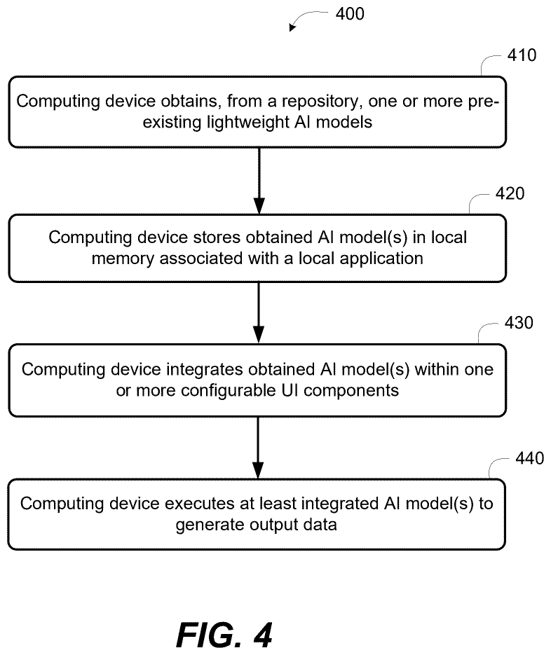

FIG. 4 is a flow diagram showing an example of a method 400 for integrating a lightweight AI model in a configurable UI component, according to some implementations. Means for performing the functionality illustrated in one or more of the operations shown in FIG. 4 may include hardware and/or software components of a user system such as a user's computing device, in some implementations.

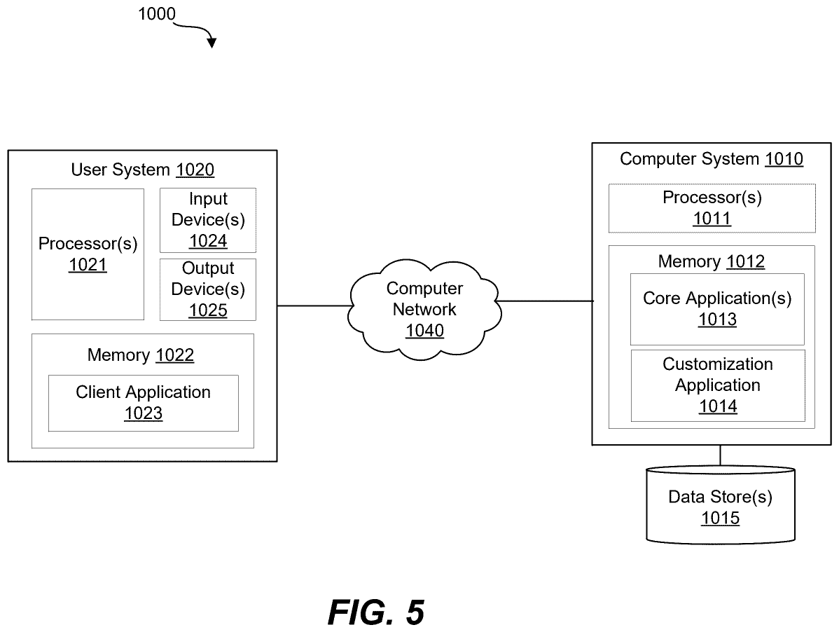

In FIG. 4, at 410, the functionality comprises the user's computing device obtaining, from a repository, one or more pre-existing lightweight AI models. For instance, the repository can include a private hub and/or a public hub hosting a number of different AI models. At 420, the functionality comprises the computing device storing the obtained one or more AI models in local memory associated with a local application at the computing device. Local applications can include: a web browser, a software application, a mobile app, or some combination thereof. At 430, the functionality comprises the computing device integrating the obtained one or more AI models within one or more configurable UI components of the local application. For instance, operations at 430 can be facilitated using a scripting library configured to enable local execution of AI models in the local application at the computing device. Then, at 440, the functionality comprises the computing device executing at least the integrated one or more AI models to generate output data. For example, the integrated one or more AI models can be executed in an offline mode of the computing device using local data stored at the computing device. Such an offline mode can correspond to: no network connection, no communication with a server system, or a combination thereof. Means for performing functionality at 410 through 440 may comprise components of a user system, as illustrated in FIG. 5.

FIG. 5 is a diagram showing an example of a computing environment 1000, according to some implementations. The computing environment 1000 includes a computer system 1010 and a user system 1020, which may communicate through one or more computer networks 1040 (e.g., the internet). The computer network(s) 1040 may include one or more wireless networks, one or more wired networks, or a combination of wired and wireless networks. For example, computer network(s) 1040 may be any one or any combination of one or more LANs (local area networks), WANs (wide area networks), telephone networks, and wireless networks, among others.

The user system 1020, such as a user's computing device, may include a client application 1023, also referred to herein as a local application, configured to interact with computer system 1010. The client application 1023 may be a web browser or thin-client program configured to communicate with computing system 1010, for example, through one or more application programming interfaces (APIs). As an example, a web API may enable exchange of Hypertext Transfer Protocol (HTTP) requests and responses between client application 1023 and applications running on computer system 1010, such as one or more core applications 1013 and/or a customization application 1014. Alternatively, in some implementations, core application(s) 1013 and/or customization application 1014 may be installed and executed on user system 1020 as a standalone program. The user system 1020 may include one or more processors 1021 and memory 1022. The processor(s) 1021 may include general-purpose processors, special-purpose processors, or combinations thereof. The memory 1022 may include one or more memory devices comprising non-volatile storage, volatile storage, or a combination thereof. Further, the user system 1020 may include one or more input devices 1024 (e.g., keyboard, touchscreen, etc.) and one or more output devices 1025 (e.g., display screen(s), headset, printer, etc.).

The computer system 1010 may provide various cloud-based services such as one or more core applications 1013 and/or customization application 1014. The computer system 1010 may include one or more processors 1011 and memory 1012. The processor(s) 1011 may include general-purpose processors, special-purpose processors, or combinations thereof. The memory 1012 may include one or more memory devices comprising non-volatile storage, volatile storage, or a combination thereof. The computer system 1010 may be configured to provide access to one or more core applications 1013 and/or customization application 1014, for example, upon execution by processor(s) 1011. In various implementations, computer system 1010 may implement a Software as a Service (SaaS) model, a Platform as a Service (PaaS) model, or any other cloud computing model, to facilitate access to core application(s) 1013 and/or customization application 1014. For instance, computer system 1010 may implement operations and functionality of a public hub or a private hub.

In some other implementations, core application(s) 1013 may be provided to users associated with one or more tenants (e.g., enterprise organizations) of computer system 1010 and may provide functionality relating to sales, customer support, customer relationship management (CRM), marketing, finance, messaging, electronic commerce, data analytics, for example. Thus, core application(s) 1013 may form a software suite available to users of computer system 1010, for example, on a subscription basis. In some implementations, servers in different data centers may provide core application(s) 1013. In various implementations, customization application 1014 may be configured to generate custom mobile applications using an image of a base application, as described herein.

The computer system 1010 may be associated with one or more data stores 1015, which may be accessible through wired or network-based connections. For instance, data store(s) 1015 may store pre-existing AI model data to implement a public hub or a private hub in cooperation with computer system 1010.

In some other implementations, data store(s) 1015 may include tenant-specific data that can only be accessed by users associated with the same tenant. In a multi-tenant environment, computer system 1010 may isolate the data store(s) such that users associated with one tenant have no access or visibility into local data belonging to a different tenant. Further, within a single tenant, access permissions may be configured on a user-by-user basis, such that permission levels may vary among users, for example, based on position, title, role, etc. The data store(s) 1015 may store various tenant-specific data, such as data relating to sales, customer support, customer relationship management (CRM), marketing, finance, messaging, electronic commerce, data analytics, and/or the like.

Each of user system 1020 and computer system 1010 includes hardware elements that can be electrically coupled via a bus (or may otherwise be in communication, as appropriate). The hardware elements may include processor(s), which may include without limitation one or more general-purpose processors, one or more special-purpose processors (such as digital signal processing chips, graphics acceleration processors, and/or the like), and/or other processing structure, which can be configured to perform one or more of the methods described herein.

Each of user system 1020 and computer system 1010 may further include (and/or be in communication with) one or more non-transitory storage devices, which can include, without limitation, local and/or network accessible storage, and/or may include, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices, as described herein.

In some implementations, each of user system 1020 and computer system 1010 includes a working memory, which may include a RAM or ROM device. Software elements located within the working memory may include an operating system, device drivers, executable libraries, and/or other code, such as one or more applications, which may include computer programs provided by some implementations, and/or may be designed to implement methods, and/or configure systems, provided by some other implementations, as described herein. Merely by way of example, one or more procedures described with respect to the method(s) discussed herein might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of instructions and/or code might be stored on a non-transitory computer-readable storage medium, such as the storage device(s) described above. In some cases, the storage medium might be incorporated within a computer system, such as user system 1020 or computer system 1010. In some other implementations, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by user system 1020 or computer system 1010 and/or might take the form of source and/or installable code, which, upon compilation and/or installation on user system 1020 or computer system 1010 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In some implementations, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various implementations may omit, substitute, or add various procedures or components as appropriate. For instance, features described with respect to certain implementations may be combined in various other implementations. Different aspects and elements of the implementations may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to signals as bits, data, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that discussion utilizing terms such as “processing,” “computing,” “calculating,” “determining,” “ascertaining,” “identifying,” “associating,” “measuring,” “performing,” or the like refers to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Having described several implementations, various modifications, alternative constructions, and equivalents may be used without departing from the scope of the disclosure. For example, the above elements may merely be a component of a larger system, wherein other rules may take precedence over or otherwise modify the application of the various implementations. Also, a number of steps may be undertaken before, during, or after the above elements are considered. Accordingly, the above description does not limit the scope of the disclosure.

What is claimed is:

1. A computer-implemented method of integrating a lightweight artificial intelligence (AI) model in a configurable user interface component, the method comprising:
obtaining, by a computing device from a repository, one or more pre-existing lightweight AI models;
storing, by the computing device, the obtained one or more AI models in local memory associated with a local application at the computing device;
integrating, by the computing device, using a scripting library configured to enable local execution of AI models in the local application at the computing device, the obtained one or more AI models within one or more configurable user interface components of the local application; and
executing, by the computing device, at least the integrated one or more AI models to generate output data.

2. The method of claim 1, wherein executing at least the integrated one or more AI models includes:
executing the integrated one or more AI models in an offline mode of the computing device using local data stored at the computing device, the offline mode corresponding to: no network connection, no communication with a server system, or a combination thereof.

3. The method of claim 1, wherein executing at least the integrated one or more AI models includes:
executing the integrated one or more AI models as part of executing the local application.

4. The method of claim 1, further comprising:
customizing the obtained one or more AI models according to input data.

5. The method of claim 1, wherein the local application includes: a web browser, a software application, a mobile app, or a combination thereof.

6. The method of claim 1, wherein the component is a lightning web component (LWC).

7. The method of claim 1, wherein the repository includes one or more of a private hub or a public hub hosting a plurality of different AI models.

8. A non-transitory computer-readable medium storing program code including instructions executable by one or more processors of a computing device to cause:
obtaining, by the computing device from a repository, one or more pre-existing lightweight AI models;
storing, by the computing device, the obtained one or more AI models in local memory associated with a local application at the computing device;
integrating, by the computing device, using a scripting library configured to enable local execution of AI models in the local application at the computing device, the obtained one or more AI models within one or more configurable user interface components of the local application; and
executing, by the computing device, at least the integrated one or more AI models to generate output data.

9. The non-transitory computer-readable medium of claim 8, wherein executing at least the integrated one or more AI models includes:
executing the integrated one or more AI models in an offline mode of the computing device using local data stored at the computing device, the offline mode corresponding to: no network connection, no communication with a server system, or a combination thereof.

10. The non-transitory computer-readable medium of claim 8, wherein executing at least the integrated one or more AI models includes:
executing the integrated one or more AI models as part of executing the local application.

11. The non-transitory computer-readable medium of claim 8, the instructions being executable to further cause:
customizing the obtained one or more AI models according to input data.

12. The non-transitory computer-readable medium of claim 8, wherein the local application includes: a web browser, a software application, a mobile app, or a combination thereof.

13. The non-transitory computer-readable medium of claim 8, wherein the component is a lightning web component.

14. The non-transitory computer-readable medium of claim 8, wherein the repository includes one or more of a private hub or a public hub hosting a plurality of different AI models.

15. A computing device comprising:
one or more memories;
one or more processors communicatively coupled with the one or more memories, the one or more processors configured to cause:
obtaining, from a repository, one or more pre-existing lightweight AI models;
storing, in the one or more memories, the obtained one or more AI models in association with a local application at the computing device;
integrating, using a scripting library configured to enable local execution of AI models in the local application at the computing device, the obtained one or more AI models within one or more configurable user interface components of the local application; and
executing at least the integrated one or more AI models to generate output data.

16. The computing device of claim 15, wherein executing at least the integrated one or more AI models includes:
executing the integrated one or more AI models in an offline mode of the computing device using local data stored at the computing device, the offline mode corresponding to: no network connection, no communication with a server system, or a combination thereof.

17. The computing device of claim 15, wherein executing at least the integrated one or more AI models includes:
executing the integrated one or more AI models as part of executing the local application.

18. The computing device of claim 15, the one or more processors being configured to further cause:
customizing the obtained one or more AI models according to input data.

19. The computing device of claim 15, wherein the local application includes: a web browser, a software application, a mobile app, or a combination thereof.

20. The computing device of claim 15, wherein the component is a lightning web component.
